(19) United States
(12) Patent Application Publication
(10) Pub. No.: US 2006/0136097 A1
(43) Pub. Date: Jun. 22, 2006

(54) Robot system

(76) Inventors: Yong-jae Kim, Seoul (KR); Min-jung Kim, Seoul (KR); Yeon-taek Oh, Yongin-si (KR); Youn-Baek Lee, Suwon-si (KR); Jun-pyo Hong, Suwon-si (KR)

Correspondence Address: STANZIONE & KIM, LLP, 919 18TH STREET, N.W., SUITE 440, WASHINGTON, DC, 20006, US

(21) Appl. No.: 11/294,497

(22) Filed: Dec. 6, 2005

(30) Foreign Application Priority Data
Dec. 17, 2004 (KR) 2004-107933

(51) Int. Cl. G06F 19/00

(52) U.S. Cl. 700/258; 700/245

(57) ABSTRACT

A robot system includes a position information emitting unit including a light emitter to emit a light including phase information and a supersonic wave emitter to emit a supersonic wave, and a robot including a light receiver to receive the light, a supersonic wave receiver to receive the supersonic wave, and a position determining part to determine a relative position of the robot with respect to the position information emitting unit based on the phase information of the light received through the light receiver and the supersonic wave received through the supersonic wave receiver. Thus the robot system can precisely determine the position of the robot regardless of external environments, and reduce cost of a configuration of the system.

### CROSS-REFERENCE TO RELATED APPLICATIONS

This application claims the benefit under 35 U.S.C. §119 of Korean Patent Application No. 2004-107933, filed on Dec. 17, 2004, in the Korean Intellectual Property Office, the disclosure of which is incorporated herein in its entirety by reference.

### BACKGROUND OF THE INVENTION

1. Field of the Invention

The present general inventive concept relates to a robot system, and more particularly, to a robot system to detect a position and/or proceeding direction of a robot by a light and/or a supersonic wave emitted from a position information emitting unit.

2. Description of the Related Art

Robots are widely used in all fields of industry, to manage household duties, etc.

In the past, the robot was seated in a limited space or moved along a predetermined track. However, recently, the robot which automatically moves and operates beyond the predetermined track has been developed.

To move a mobile robot to a target place, there have been proposed various methods, such as detecting a guide line provided on a moving path, etc.

FIG. 1 illustrates a configuration of a conventional robot system in which a mobile robot 300 determines its current position.

As shown in FIG. 1, the conventional robot system comprises the robot 300 and a light emitting unit 100.

The light emitting unit 100 includes a plurality of light emitters 101 placed at a predetermined position and emitting a light, such as an infrared ray, an electromagnetic wave, or the like, which travels in a straight line.

Because the light emitted from the light emitters 101 travels in the straight line, the lights emitted from the respective light emitters 101 reach the robot 300 positioned in a predetermined area corresponding to the position of the light emitting unit 100. Further, the respective light emitters 101 emit lights comprising inherent ID information to identify the light emitters 101 with respect to each other.

Meanwhile, the robot 300 comprises a plurality of light receivers 301 and a controller (not shown).

The light receivers 301 receive the light emitted from the light emitting unit 100, and output information on intensity of the received light to the controller.

The controller determines the relative position of the robot 300 with respect to the light emitters 101 based on the intensity information of the light received through the light receivers 301.

However, it is difficult for the conventional robot system to accurately determine the intensity of the light according to a specification of the light emitters 101 and the light receivers 301, so that it is difficult to precisely determine the respective position of the robot 300 based on the intensity of the light.

Further, an energy of the light traveling in a space is decreased in inverse proportion to a cubed distance from the light emitter 101, so that determining the position based on the intensity of the light is limited by the distance between the light emitting unit 100 and the robot 300.

### SUMMARY OF THE INVENTION

Accordingly, the present general inventive concept provides a robot system to precisely determine a position of a robot regardless of external environments, and to reduce cost of a configuration of the robot system.

Additional aspects and advantages of the general inventive concept will be set forth in part in the description which follows and, in part, will be obvious from the description, or may be learned by practice of the general inventive concept.

The foregoing and/or other aspects and advantages of the present general inventive concept may be achieved by providing a robot system comprising a position information emitting unit comprising a light emitter to emit light comprising phase information and a supersonic wave emitter to emit a supersonic wave, and a robot comprising a light receiver to receive the light, a supersonic wave receiver to receive the supersonic wave, and a position determining part to determine a relative position of the robot with respect to the position information emitting unit based on the phase information of the light received through the light receiver and the supersonic wave received through the supersonic wave receiver.

The robot may further comprise a proceeding direction detector to detect a proceeding direction of the robot based on an incident angle of the received light.

The position determining part may determine a phase of the robot with respect to the position information emitting unit based on the phase information of the light received through the light receiver.

The light emitted by the light emitter may comprise time information regarding a time when the supersonic wave is emitted from the supersonic wave emitter, and the position determining part may determine the distance between the position information emitting unit and the robot based on the time information and a receiving time of the supersonic wave.

The position determining part may determine the distance between the position information emitting unit and the robot based on an emitting period of the light emitted from the light emitter, the phase information of the light, and a receiving time of the supersonic wave.

The proceeding direction detector may comprise a lens to concentrate the received light and a light detector to detect a concentrated position of the light concentrated by the lens and may transmit information regarding the concentrated position of the concentrated light into the position determining part.

The light detector may comprise at least one of a position sensitive diode (PSD), a charged coupled devices (CCD) sensor, and a complementary metal oxide semiconductor (CMOS) sensor.

The light emitter may comprise a light outputting part to output the light including the phase information, and a phase adjustor to adjust an emitting direction of the light to emit the light from the light outputting part toward a direction corresponding to the phase information.

The light emitted by the light may further comprise ID information corresponding to the position information emitting unit, and the position determining part may detect the position of the position information emitting unit on a working space based on the ID information and determine an absolute position of the robot on the working space based on the detected position of the position information emitting unit on the working space and the relative position of the robot with respect to the position information emitting unit.

The foregoing and/or other aspects and advantages of the present general inventive concept may also be achieved by providing a robot system comprising a position information emitting unit comprising a light emitter to emit light comprising phase information, and a robot comprising a light receiver to receive the light, a position determining part to determine a phase of the robot with respect to the position information emitting unit based on the phase information of the light received through the light receiver, and a proceeding direction detector to detect a proceeding direction of the robot based on an incident angle of the light.

The position information emitting unit may further comprise a supersonic wave emitter to emit a supersonic wave, the robot may further comprise a supersonic wave receiver to receive the supersonic wave emitted from the supersonic wave emitter, and the position determining part may determine a distance between the position information emitting unit and the robot based on a receiving time of the supersonic wave received through the supersonic wave receiver.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1 illustrates a configuration of a conventional robot system;

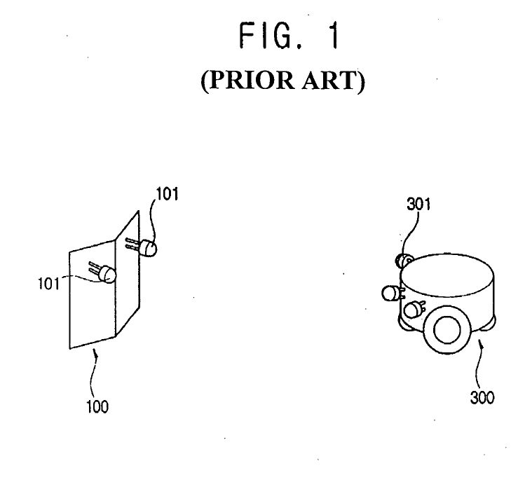

FIG. 2 illustrates a control block diagram of a robot system according to an embodiment of the present general inventive concept;

FIG. 3 illustrates a position information emitting unit of the robot system of FIG. 2;

FIG. 4 illustrates a robot of the robot system of FIG. 2;

FIG. 5 illustrates a calculating method of a proceeding direction and a position of the robot of the robot system of FIG. 2;

FIG. 6 illustrates a proceeding direction detector of the robot system of FIG. 2; and

FIG. 7 illustrates a configuration of a robot system according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

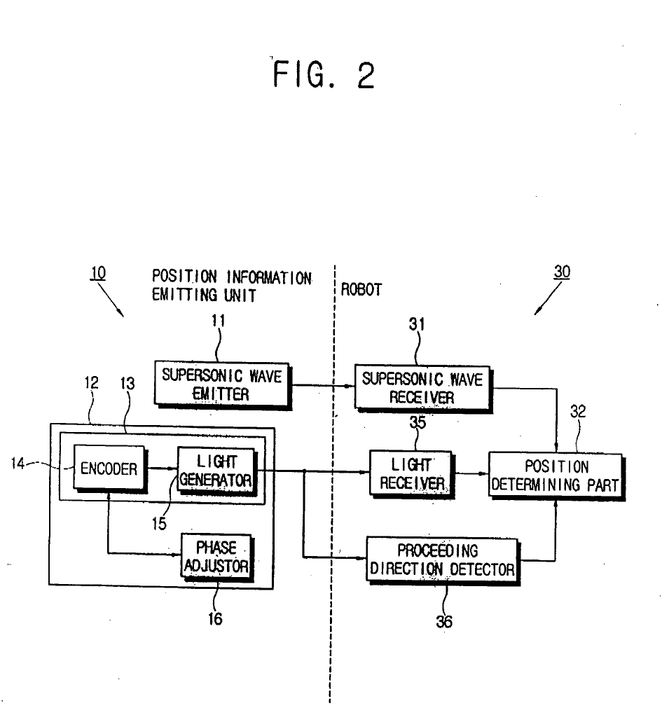

FIG. 2 illustrates a robot system according to an embodiment of the present general inventive concept. Referring to FIG. 2, the robot system comprises a position information emitting unit 10 and a robot 30.

The position information emitting unit 10 comprises a light emitter 12 to emit light including position information and a supersonic wave emitter 11 to emit a supersonic wave.

The light emitter 12 comprises a light outputting part 13 to emit the light to travel in a straight line, and a phase adjustor 16 to adjust an emitting direction of the light emitted from the light outputting part 13 to correspond to phase information of the light.

The light outputting part 13 outputs the light, such as an infrared ray, an electromagnetic wave, or the like, which travels in a straight line. Here, the light outputting part 13 includes various information in the output light by phase-shift keying, frequency-shift keying, etc. Accordingly, the light output through the light outputting part 13 comprises the phase information regarding the phase of the emitted light to be adjusted by the phase adjustor 16. When the light output from the light outputting part 13 is infrared rays, the phase information may be provided in the infrared rays by an infrared data association (IrDA) infrared rays communication.

The phase adjustor 16 adjusts the emitting direction of the light output from the light outputting part 13 to correspond to the phase information of the light output from the light outputting part 13.

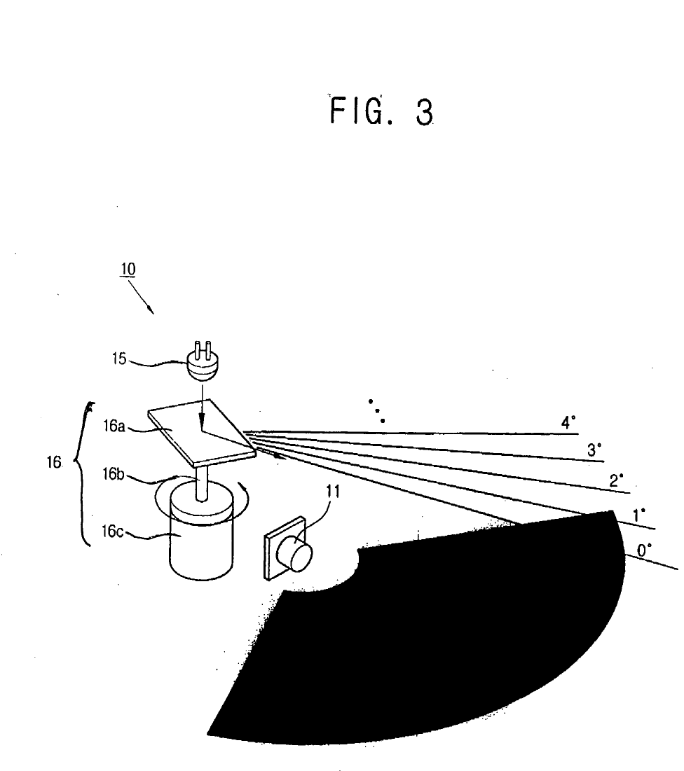

FIG. 3 illustrates the position information emitting unit 10 of the robot system. Referring to FIG. 3, the phase adjustor 16 may comprise a reflecting mirror 16a, a rotating shaft 16b, and a motor 16c.

The reflecting mirror 16a is connected to the rotating shaft 16b and is disposed to incline with respect to the emitting direction of the light output from the light outputting part 13 to reflect the light output from the light outputting part 13 at a predetermined incident angle.

The rotating shaft 16b is connected to the reflecting mirror 16a and transmits a rotating power of the motor 16c to the reflecting mirror 16c. The motor 16c rotates the rotating shaft 16b to rotate the reflecting mirror 16a at a predetermined angular velocity. Here, the motor 16c can rotate the reflecting mirror 16a by, 360 degrees to adjust the emitting direction of the light output from the light outputting part 13.

Returning to FIG. 2, the light outputting part 13 may comprise a light generator 15 to generate the light and an encoder 14 to encode the phase information, which is the same as the phase of the light actually emitted by the rotation of the motor 16c, into the light.

The encoder 14 receives information regarding the phase according to the actual rotation of the motor 16c from the motor 16c, and codes or modulates the received information to be included with the light generated in the light generator 15 as the phase information. Accordingly, the emitting direction of the light output from the light outputting part 13 is adjusted to correspond to the phase information of the light by the phase adjustor 16.

As described above, the encoder 14 may encode the phase information into the light by phase-shift keying, frequency-shift keying, a PWM (phase width modulation) method, or the like, according to the light type.

The supersonic wave emitter 11 emits the supersonic wave to be synchronized with the light emitted from the light emitter 12. Here, the encoder 14 may control the supersonic wave emitter 11 to emit the supersonic wave at a predetermined period when the supersonic wave is synchronized with the light generated by the light generator 15. For example, the supersonic wave emitter 11 can emit the supersonic wave whenever the motor 16c makes 1 rotation, i.e. whenever the phase according to the phase information of the light output from the light outputting part 12 is zero degrees.

According to the foregoing configuration, the light and the supersonic wave emitted from the position information emitting unit 10 are emitted as described below.

The motor 16c rotates at a predetermined angular velocity. When the phase of the motor is zero degrees, the encoder 14 controls the light generator 15 to generate and output the light including the phase information of zero degrees. When the encoder 14 controls the light generator 15 to generate and output the light including the phase information of zero degrees, the encoder 14 simultaneously controls the supersonic wave emitter 11 to emit the supersonic wave.

The encoder 14 controls the light generator 15 to output the light by a predetermined phase increment, for example, a one degree increment as illustrated in FIG. 3, to correspond to the rotation of the motor 16c, and also encodes the phase information of the light output from the light generator 15 by the predetermined phase increment.

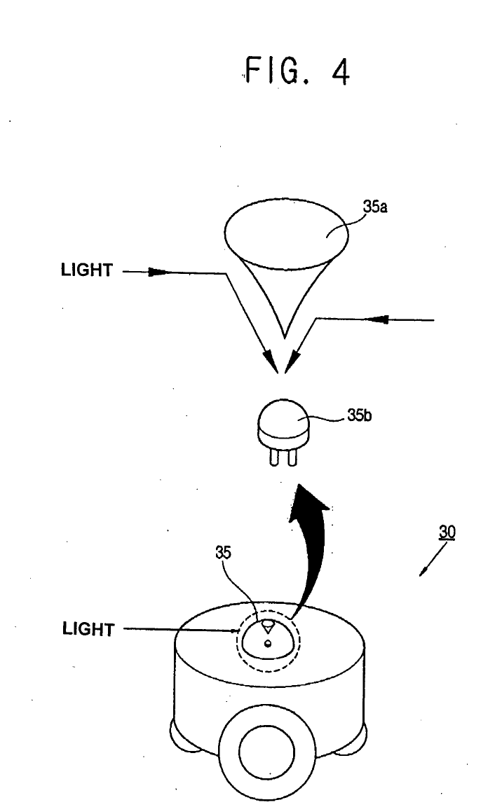

FIG. 4 illustrates the robot 30 of the robot system of FIG. 2. Referring to FIGS. 2 and 4, the robot 30 may comprise a light receiver 35, a supersonic wave receiver 31, a proceeding direction detector 36, and a position determining part 32.

The light receiver 35 receives the light emitted from the light emitter 12 of the position information emitting part 10. Also, the light receiver 35 transmits the received light to the position determining part 32. As illustrated in FIG. 4, the light receiver 35 can receive the light from a plurality of horizontal directions with respect to a proceeding direction of the robot 30. Here, the light receiver 35 comprises a conical mirror 35a of a cone shape, to concentrate the light horizontally received into a tip thereof, and then transmit the concentrated light to a light receiving part 35b. Further, the light receiver 35 may alternatively be provided in various shapes.

Although FIG. 4 illustrates the light receiver 35 of the robot 30 comprising the conical mirror 35a and the light receiving part 35b, the light receiver 35 of the robot 30 according to the present general inventive concept may alternately comprise other configurations as long as the light receiver 35 receives the light from a plurality of substantially horizontal directions with respect to the proceeding direction of the robot 30.

The supersonic wave receiver 31 receives the supersonic wave emitted from the supersonic wave emitter 11 of the position information emitting unit 10. Also, the supersonic wave receiver 31 can transmit information to the position determining part 32 whether the supersonic wave is received or not.

The robot 30 detects a phase and a distance thereof with respect to the position information emitting unit 10 based on the phase information of the light received through the light receiver 35 and the supersonic wave received through the supersonic wave receiver 31. Accordingly, the robot 30 may detect a relative position thereof with respect to the position information emitting unit 10 with only one light receiver 35, so that a manufacturing cost of the robot 30 may be reduced. Also, when the phase and the distance are detected based on information received through one light receiver 35, a detecting error, which is generated in a state in which a plurality of light receivers are adjacently provided, is eliminated.

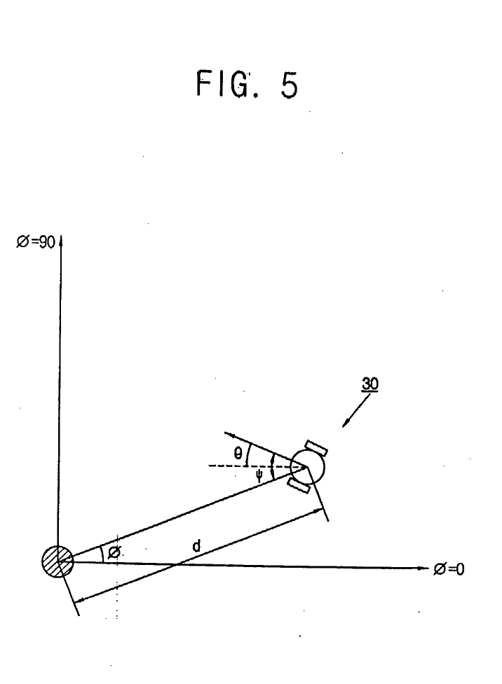

FIG. 5 illustrates a method used by the position determining part 32 to detect the relative phase and position of the robot 30 with respect to the position information emitting unit 10 based on the light received through the light receiver 35 and the supersonic wave received through the supersonic wave receiver 31.

Referring to FIG. 5, first, the position determining part 32 decodes the phase information of the light received through the light receiver 35 to detect a relative phase φ of the robot 30 with respect to the position information emitting unit 10.

The position determining part 32 calculates a distance d between the robot 30 and the position information emitting unit 10 based on the supersonic wave received through the supersonic wave receiver 31 and the light received through the light receiver 35.

For example, a receiving time of the supersonic wave received through the supersonic wave receiver 31 is Ts and a time when the light emitter 12 emits the light having the phase φ of zero degrees and the supersonic wave emitter 11 emits the supersonic wave is T0.

Accordingly, it takes Ts−T0 for the supersonic wave emitted from the supersonic wave emitter 11 to reach the supersonic wave receiver 31. Accordingly, the distance d between the robot 30 and the position information emitting unit 10 is calculated by expression 1, below.

Expression 1
d=(Ts−T0)×Vs, Vs is the velocity of sound.

Here, the encoder 14 of the position information emitting unit 10 may encode time information regarding T0 into the light emitted from the light emitter 12. Accordingly, the position determining part 32 may detect the time T0, when the supersonic wave is emitted from the supersonic wave emitter 11, according to the time information regarding T0 encoded into the light received by the light receiver 35.

Alternatively, the position determining part 32 may detect the time T0, when the supersonic wave is emitted from the supersonic wave emitter 11, by expression 2 below, based on a receiving time Tr of the light received through the light receiver 35, a ratio C of the phase φ of the light received by the light receiver 35 to the predetermined phase increment of the light emitted from the light emitter 12, and a time Tc required for the motor 16c to rotate by the predetermined phase increment.

Expression 2
T0=Tr−Tc×C

Here, at the expression 2, it is considered that a velocity of the light is very fast. Accordingly, a time required for the light to travel from the light emitter 12 to the robot 30 is not considered.

Meanwhile, the proceeding direction detector 36 detects the proceeding direction θ of the robot 30 based on an incident angle Ψ of the light emitted from the position information emitting unit 10.

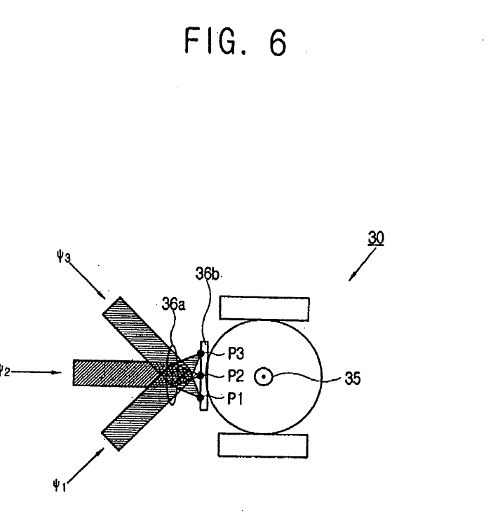

FIG. 6 illustrates the proceeding direction detector 36 detecting the proceeding direction θ of the robot 30 based on the light emitted from the position information emitting unit 10. Referring to FIG. 6, the proceeding direction detector 36 comprises a lens 36a to concentrate the light emitted from the position information emitting unit 10, and a light detector to detect the light concentrated by the lens 36a and to transmit information regarding concentrating positions P1, P2, and P3 into the position determining part 32. Here, the light detector may comprise a position sensitive diode (PSD) 36b. The PSD 36b may comprise a two-dimension (2D) PSD to detect a height difference between the position information emitting unit 10 and the robot 30. The light detector may comprise a CCD sensor, a CMOS sensor, or the like, as an alternative to the PSD 36b.

As illustrated in FIG. 6, the light emitted from the position information emitting unit 10 is concentrated to the different concentrating positions P1, P2, and P3 according to respective incident angles Ψ1, Ψ2, and Ψ3 when the light emitted from the position information emitting unit 10 passes through the lens 36a, and the light detector transmits the information regarding the concentrating positions P1, P2, and P3 of the light to the position determining part 32.

Here, the position determining part 32 receives the information regarding the concentrating positions P1, P2, and P3, of the light from the light detector, and calculates the proceeding direction θ of the current robot 30. For example, as illustrated in FIG. 5, when the Ψ is the incident angle of the light determined based on the information regarding one of the concentrating positions P1, P2, and P3 from the light detector, the proceeding direction θ with respect to the phase φ of zero degrees may be calculated by expression 3, below.

Expression 3
θ=Ψ−φ

Here, the phase φ is the relative phase of the robot 30 detected by the position determining part 32 according to the phase information of the light received through the light receiver 35.

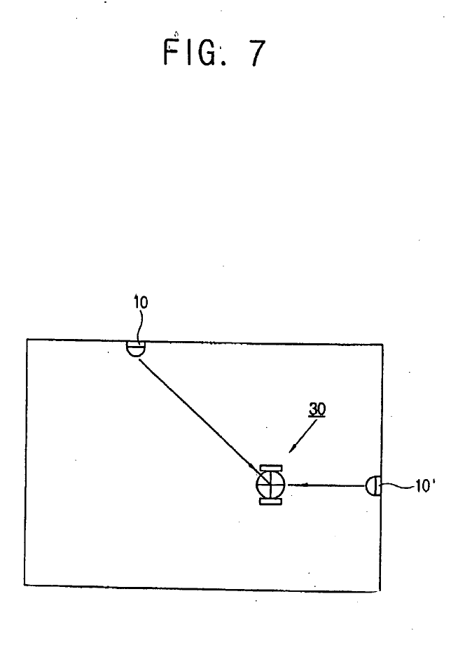

FIG. 7 illustrates a robot system comprising a plurality of the position information emitting units 10 and 10′ and a robot 30 according to another embodiment of the present general inventive concept. The configuration of the position information emitting units 10 and 10′ and the robot 30 are substantially the same as illustrated in FIG. 2, and therefore, detailed descriptions thereof are omitted.

Referring to FIG. 7, the position information emitting units 10 and 10′ are provided in predetermined positions on a working space of the robot 30. The encoder 14 of each position information emitting unit 10 and 10′ encodes the information of an ID of the corresponding position information emitting unit 10 and 10′ into the light generated by the light generator 15.

Then, the position determining part 32 of the robot 30 can determine the position of the position information emitting units 10 and 10′ on the working space based on the ID of each position information emitting unit 10 and 10′ provided in the light received by the light receiver 35. For example, in the position determining part 32 of the robot 30 is stored an information table having the IDs of the respective position information emitting units 10 and 10′ provided on the working space and the position of the position information emitting units 10 and 10′ corresponding to the IDs on the working space.

Accordingly, as described above in the previous embodiment, the position determining part 32 of the robot 30 determines the information about the distance d and the phase φ of the robot with respect to each position information emitting unit 10 and 10′, and acquires the position of each position information emitting unit 10 and 10′ on the working space corresponding to the ID information of each position information emitting unit 10 and 10′ from the information table, so that the position determining part 32 may calculate the absolute position of the robot 30 on predetermined standard coordinates of the working space.

As described above, a robot system according to the present general inventive concept calculates a relative phase and distance between a robot and a position information emitting unit, and a proceeding direction of the robot. Alternately, the robot system may detects at least one of the relative phase and the distance between the robot and the position information emitting unit, and the proceeding direction of the robot through the foregoing method, and detect the others by a different method.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A robot system comprising:
a position information emitting unit comprising a light emitter to emit light comprising phase information, and a supersonic wave emitter to emit a supersonic wave; and
a robot comprising a light receiver to receive the light, a supersonic wave receiver to receive the supersonic wave, and a position determining part to determine a relative position of the robot with respect to the position information emitting unit based on the phase information of the light received through the light receiver and the supersonic wave received through the supersonic wave receiver.

2. The robot system according to claim 1, wherein the robot further comprises a proceeding direction detector to detect a proceeding direction of the robot based on an incident angle of the light.

3. The robot system according to claim 2, wherein the position determining part determines a phase of the robot with respect to the position information emitting unit based on the phase information of the light received through the light receiver.

4. The robot system according to claim 2, wherein the proceeding direction detector comprises a lens to concentrate the light and a light detector to detect a concentrated position of the light concentrated by the lens and to transmit information regarding the concentrated position of the concentrated light into the position determining part.

5. The robot system according to claim 4, wherein the light detector comprises at least one of a position sensitive diode (PSD), a charged coupled devices (CCD) sensor, and a complementary metal oxide semiconductor (CMOS) sensor.

6. The robot system according to claim 4, wherein the position determining part determines the incident angle of the light based on the information regarding the concentrated position of the concentrated light.

7. The robot system according to claim 4, wherein the light detector comprises a two dimensional position sensitive diode to detect a height difference between the robot and the position information emitting unit.

8. The robot system according to claim 2, wherein the light emitter comprises a light outputting part to output the light including the phase information, and a phase adjustor to adjust an emitting direction of the light to emit the light output from the light outputting part toward a direction corresponding to the phase information.

9. The robot system according to claim 2, wherein the light emitter emits the light comprising ID information of the position information emitting unit, and
the position determining part of the robot detects a position of the position information emitting unit on a working space based on the ID information and determines an absolute position of the robot on the working space based on the detected position of the position information emitting unit on the working space and the relative position of the robot with respect to the position information emitting unit.

10. The robot system according to claim 1, wherein the light emitted from the light emitter further comprises time information regarding a time when the supersonic wave is emitted from the supersonic wave emitter, and
the position determining part determines a distance between the position information emitting unit and the robot based on the time information and a receiving time of the supersonic wave.

11. The robot system according to claim 1, wherein the position determining part determines a distance between the position information emitting unit and the robot based on an emitting period of the light emitted from the light emitter, the phase information of the light, and a receiving time of the supersonic wave.

12. A robot system comprising:
a position information emitting unit comprising a light emitter to emit light comprising phase information; and
a robot comprising a light receiver to receive the light emitted from the light emitter, a position determining part to determine a phase of the robot with respect to the position information emitting unit based on the phase information of the light received through the light receiver, and a proceeding direction detector to detect a proceeding direction of the robot based on an incident angle of the light emitted from the light emitter.

13. The robot system according to claim 12, wherein the position information emitting unit further comprises a supersonic wave emitter to emit a supersonic wave,
the robot further comprises a supersonic wave receiver to receive the supersonic wave emitted from the supersonic wave emitter, and
the position determining part determines a distance between the position information emitting unit and the robot based on a receiving time of the supersonic wave received through the supersonic wave receiver.

14. The robot system according to claim 13, wherein the light emitted from the light emitter further comprises time information regarding a time when the supersonic wave is emitted from the supersonic wave emitter, and
the position determining part determines the distance between the position information emitting unit and the robot based on the time information and the receiving time of the supersonic wave.

15. The robot system according to claim 13, wherein the position determining part determines the distance between the position information emitting unit and the robot based on an emitting period of the light emitted from the light emitter, the phase information of the light, and the receiving time of the supersonic wave.

16. The robot system according to claim 13, wherein the proceeding direction detector comprises a lens to concentrate the light and a light detector to detect a concentrated position of the light concentrated by the lens and to transmit information regarding the concentrated position of the concentrated light into the position determining part.

17. The robot system according to claim 16, wherein the light detector comprises at least one of a position sensitive diode (PSD), a charged coupled devices (CCD) sensor, and a complementary metal oxide semiconductor (CMOS) sensor.

18. The robot system according to claim 13, wherein the light emitter comprises a light outputting part to output the light including the phase information, and a phase adjustor to adjust an emitting direction of the light output from the light outputting part to emit the light output from the light outputting part toward a direction corresponding to the phase information.

19. The robot system according to claim 13, wherein the light emitted by the light emitter further comprises ID information corresponding to the position information emitting unit, and
the position determining part detects the position of the position information emitting unit on a working space based on the ID information and determines an absolute position of the robot on the working space based on the detected position of the position information emitting unit on the working space and a relative position of the robot with respect to the position information emitting unit.

20. A robot, comprising:
a light receiving unit to receive light encoded with phase information from a plurality of directions;
a supersonic wave receiving unit to receive a supersonic wave; and
a position determining unit to determine a relative position with respect to a source of the received light and supersonic wave based on the encoded phase information of the received light and the received supersonic wave.

21. The robot according to claim 20, further comprising:
a proceeding direction detecting unit to detect a proceeding direction with respect to the source of the received light and supersonic wave based on the encoded phase information of the received light and an incident angle of the received light.

22. The robot according to claim 20, wherein the position determining unit determines a distance from the source of the received light and supersonic wave according a receiving time of the supersonic wave, and determines an angle with respect to the source according to the encoded phase information of the received light.

23. A position information emitting unit to determine a position of a robot, the position information emitting unit comprising:
a supersonic wave emitter to emit a supersonic wave to determine a distance from the robot; and
a light emitter to emit light encoded with phase information at a plurality of angles to determine an angle with respect to the robot.

24. The position information emitting unit according to claim 23, wherein the light emitter comprises:
a light generator to generate the light;
an encoder to encode the light generated by the light generator with phase information corresponding to the plurality of angles at which the light is emitted; and
a phase adjustor to adjust the angle at which the light is emitted according to the encoded phase information.

25. The position information emitting unit according to claim 23, wherein the supersonic wave emitter emits the supersonic wave when the light emitter emits the light encoded with the phase information at a predetermined one of the plurality of angles.
